(19) United States
(12) Patent Application Publication
(10) Pub. No.: US 2024/0259163 A1
(43) Pub. Date: Aug. 1, 2024

(54) TRANSMISSION OF HARQ-ACK FOR MULTIPLE SPS OR MULTIPLE CGS FOR TRANSMISSION ALIGNMENT

(71) Applicant: Telefonaktiebolaget LM Ericsson (publ), Stockholm (SE)

(72) Inventors: Bikramjit Singh, RAASEPORI (FI); Alexey Shapin, LULEÅ (SE)

(21) Appl. No.: 18/019,690

(22) PCT Filed: Aug. 5, 2021
(86) PCT No.: PCT/IB2021/057228

§ 371 Date: Feb. 3, 2023

Related U.S. Application Data
(60) Provisional application No. 63/061,386, filed on Aug. 5, 2020.

(51) Int. Cl. H04L 5/00; H04L 1/1829

(52) U.S. Cl. CPC H04L 5/0055; H04L 1/1861

(57) ABSTRACT

Systems and methods are disclosed herein for transmission of Hybrid Automatic Repeat Request (HARQ) feedback for multiple Semi-Persistent Scheduling (SPS) or multiple Configured Grant (CG) transmission alignment. In one embodiment, a method performed by a wireless communication device comprises receiving N configurations, where N is an integer greater than one and the N configurations are N downlink semi-persistent scheduling. SPS, configurations or N uplink configured grant, CG, configurations. The method further comprises sending or receiving HARQ feedback for N physical uplink or downlink shared channels that are associated to the N configurations and belong to a same period, using a HARQ codebook that comprises a single HARQ acknowledgement or negative acknowledgement. ACK/NACK, for the N physical uplink or downlink shared channels. In this manner, construction of a smaller HARQ codebook is enabled, which helps in saving resources.

### RELATED APPLICATIONS

This application claims the benefit of U.S. Provisional Patent Application No. 63/061,386, filed Aug. 5, 2020, the disclosure of which is hereby incorporated herein by reference in its entirety.

### TECHNICAL FIELD

The present disclosure relates to transmission of Hybrid Automatic Repeat Request (HARQ) feedback in a cellular communications system.

### BACKGROUND

### I. New Radio (NR)

New Radio (NR) standard in Third Generation Partnership Project (3GPP) is designed to provide service for multiple use cases such as enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot is a concept that is used in scheduling. In downlink (DL), a min-slot can consist of 2, 4, or 7 Orthogonal Frequency Division Multiplexing (OFDM) symbols. In uplink (UL), a mini-slot can be any number of 1 to 14 OFDM symbols. It should be noted that the concepts of slot and mini-slot are not specific to a specific service meaning that a mini-slot may be used for either eMBB, URLLC, or other services.

FIG. 1 illustrates an exemplary radio resource in NR.

### II. Downlink Control Information

In 3GPP NR standard, Downlink Control Information (DCI), which is transmitted in Physical Downlink Control Channel (PDCCH), is used to indicate the DL data related information, UL related information, power control information, slot format indication, etc. There are different formats of DCI associated with each of these control signals, and the User Equipment (UE) identifies them based on different Radio Network Temporary Identifiers (RNTIs).

A UE is configured by higher layer signaling to monitor for DCIs in different resources with different periodicities, etc. DCI formats 1_0, 1_1, and 1_2 are used for scheduling DL data, which is sent in Physical Downlink Shard Channel (PDSCH), and includes time and frequency resources for DL transmission, as well as modulation and coding information, Hybrid Automatic Repeat Request (HARQ) information, etc.

In case of DL Semi-Persistent Scheduling (SPS) and UL configured grant type 2, part of the scheduling including the periodicity is provided by the higher layer configurations, while the rest of scheduling information such as time domain and frequency domain resource allocation, modulation and coding, etc., are provided by the DCI in PDCCH.

### III. Uplink Control Information

Uplink Control Information (UCI) is a control information sent by a UE to a NR base station (gNB). It consists of:
HARQ Acknowledgement (HARQ-ACK) which is a feedback information corresponding to the received downlink transport block whether the transport block reception is successful or not,
Channel State Information (CSI) related to downlink channel conditions which provides gNB with channel-related information useful for DL scheduling, including information for multi-antenna and beamforming schemes, and
Scheduling Request (SR) which indicates a need of UL resources for UL data transmission.

UCI is typically transmitted on Physical Uplink Control Channel (PUCCH). However, if a UE is transmitting data on the PUSCH with a valid PUSCH resource overlapping with PUCCH, UCI can be multiplexed with UL data and transmitted on PUSCH instead, if the timeline requirements for UCI multiplexing are met.

### IV. Physical Uplink Control Channel

PUCCH is used by a UE to transmit HARQ-ACK feedback message corresponding to the reception of DL data transmission. It is also used by the UE to send CSI or to request for an uplink grant for transmitting UL data.

In NR, there exist multiple PUCCH formats supporting different UCI payload sizes. PUCCH formats 0 and 1 support UCI up to 2 bits, while PUCCH formats 2, 3, and 4 can support UCI of more than 2 bits. In terms of PUCCH transmission duration, PUCCH formats 0 and 2 are considered short PUCCH formats supporting PUCCH duration of 1 or 2 OFDM symbols, while PUCCH formats 1, 3, and 4 are considered as long formats and can support PUCCH duration from 4 to 14 symbols.

### V. HARQ Feedback for DL Transmission

The procedure for receiving a downlink transmission is that the UE first monitors and decodes a PDCCH in slot n which points to a DL data scheduled in slot n+K₀ slots (K₀ is larger than or equal to 0). The UE then decodes the data in the corresponding PDSCH. Finally, based on the outcome of the decoding, the UE sends an acknowledgement of the correct decoding Acknowledgment (ACK) or a Negative Acknowledgement (NACK) to the gNB at time slot n+K₀+K₁ (in case of slot aggregation n+K₀ would be replaced by the slot where PDSCH ends). Both of K₀ and K₁ are indicated in the DCI. The resources for sending the acknowledgement are indicated by PUCCH Resource Indicator (PRI) field in the DCI which points to one of PUCCH resources that are configured by higher layers.

Depending on DL/UL slot configurations, or whether carrier aggregation, or per Code-Block Group (CBG) transmission used in the DL, the feedback for several PDSCHs may need to be multiplexed in one feedback. This is done by constructing HARQ-ACK codebooks. In NR Rel-15, the UE can be configured to multiplex the acknowledgment (A)/Negative Acknowledgement (N) bits using a semi-static codebook or a dynamic codebook. One-shot and enhanced dynamic HARQ codebooks are introduced in Rel-16 NR.

FIG. 2 illustrates the timeline in a simple scenario with two PDSCHs and one feedback. In this example there is in total 4 PUCCH resources configured, and the PRI indicates PUCCH format 2 is to be used for HARQ feedback. We explain in the following how PUCCH format 2 is selected from 4 PUCCH resources based on the procedure in Rel-15.

In NR Rel-15, a UE can be configured with a maximum of 4 PUCCH resource sets for transmission of HARQ-ACK information. Each set is associated with a range of UCI payload bits including HARQ-ACK bits. The first PUCCH resource set is always associated to 1 or 2 HARQ-ACK bits and hence includes only PUCCH format 0 or 1 or both. The range of payload values (minimum of maximum values) for other PUCCH resource sets, if configured, is provided by configuration except the maximum value for the last PUCCH resource set where a default value is used and the minimum value of the second PUCCH resource set being 3. The first PUCCH resource set can include a maximum of 32 PUCCH resources of PUCCH format 0 or 1. Other PUCCH resource sets can include a maximum 8 bits of PUCCH format 2 or 3 or 4.

As described previously, the UE determines a slot for transmission of HARQ-ACK bits in a PUCCH corresponding to PDSCHs scheduled or activated by DCI via K₁ value provided by configuration or a field in the corresponding DCI. The UE forms a codebook from the HARQ-ACK bits with associated PUCCH in a same slot via corresponding K₁ values. The UE determines a PUCCH resource set for which the size of the codebook is within the corresponding range of payload values associated to that PUCCH resource set. The UE determines a PUCCH resource in that PUCCH resource set, if the set is configured with a maximum 8 PUCCH resources, by a field in the last DCI associated to the corresponding PDSCHs. If the PUCCH resource set is the first set and is configured with more than 8 PUCCH resources, a PUCCH resource in that set is determined by a field in the last DCI associated to the corresponding PDSCHs and implicit rules based on the Control Channel Element (CCE).

A PUCCH resource for HARQ-ACK transmission can overlap in time with other PUCCH resources for CSI and/or SR transmissions as well as PUSCH transmissions in a slot. In case of overlapping PUCCH and/or PUSCH resources, first the UE resolves overlapping between PUCCH resources, if any, by determining a PUCCH resource carrying the total UCI (including HARQ-ACK bits) such that the UCI multiplexing timeline requirements are met. There might be partial or complete dropping of CSI bits, if any, to multiplex the UCI in the determined PUCCH resource. Then, the UE resolves overlapping between PUCCH and PUSCH resources, if any, by multiplexing the UCI on the PUSCH resource if the timeline requirements for UCI multiplexing are met.

### A. Semi-Static (Type-1) HARQ Codebook

Type 1 or semi-static codebook consists of a bit sequence where each element contains the A/N bit from a possible allocation in a certain slot, carrier, or Transport Block (TB). When the UE is configured with CBG and/or Time-Domain Resource Allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The drawback of semi-static HARQ ACK codebook is that the size is fixed and, regardless of whether there is a transmission or not, a bit is reserved in the feedback matrix.

In the case when a UE has a TDRA table with multiple time-domain resource allocation entries configured, the table is pruned (i.e., entries are removed based on a specified algorithm) to derive a TDRA table that only contains non-overlapping time-domain allocations. One bit is then reserved in the HARQ CB for each non-overlapping entry, assuming a UE is capable of supporting reception of multiple PDSCH in a slot.

### B. Dynamic (Type-2) HARQ Codebook

In type 2 or dynamic HARQ codebook, an A/N bit is present in a codebook only if there is a corresponding transmission scheduled. To avoid any confusion between the gNB and the UE, on the number of PDSCHs that the UE has to send a feedback for, a counter Downlink Assignment Indicator (DAI) field exists in DL assignment, which denotes accumulative number of {serving cell, PDCCH occasion} pairs in which a PDSCH is scheduled to a UE up to the current PDCCH. In addition to that, there is another field called total DAI, which when present shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K₀) and the PUCCH slot that contains HARQ feedback (K₁).

### C Enhanced Dynamic (Type-2) HARQ Codebook

In Rel-16, enhanced dynamic codebook or enhanced Type-2 codebook based on Type 2 codebook is introduced to enable retransmission of the HARQ feedback corresponding to the used HARQ processes. If, for any reason, the scheduled codebook was not received, the retransmission of the feedback can be requested by the gNB. A toggle bit, new feedback indicator (NFI), is added in the DCI to indicate whether the HARQ-ACK feedback from the UE was received by the gNB or not. If toggled (as in FIG. 3), the UE assumes that the reported feedback was correctly received. Otherwise, if the gNB fails to receive the scheduled PUCCH (FIG. 4), the UE is expected to retransmit the feedback. In the latter case, the DAI (C/T-DAI) is not reset, instead the DAI are accumulated within a PDSCH group until NFI for the PDSCH group is toggled.

FIG. 3 illustrates successful reception of PUCCH by the gNB. FIG. 4 illustrates a PUCCH misdetection case where the gNB requests retransmission of earlier feedback. Note that in this example, 2-bits DAI is assumed. Hence, the actual DAI for the last scheduled PDSCH is 5, but shown as 1=5 mod 2.

As the triggering of additional HARQ feedback reporting occurs with ambiguous timing relation to the associated PDSCHs, PDSCH grouping is introduced. PDSCH group is defined as the PDSCH(s) for which the HARQ-ACK information is originally indicated to be carried in a same PUCCH. PDSCH grouping allows the gNB to explicitly indicate which exact codebook is missing. The group index is explicitly signaled in the scheduling DCI. If enhanced dynamic codebook is configured, two PDSCH groups are supported. Together with the group ID, the gNB signals a request group ID which is a 1-bit field. If set to 0, the gNB is requesting feedback for the scheduled group, otherwise, for both the group scheduling using the DCI and the other one. By referring to the group Id (ID), request ID (RI), and the value of the NFI field in the DCI, the UE can figure out if the next feedback occasion should include only initial transmission or also retransmission of feedback corresponding to PDSCH(s) associated with the indicated group. An example for enhanced dynamic HARQ codebook with two PDSCH groups is shown in FIG. 5.

Similar to NR, the DAI value is also included in the UL grant scheduling PUSCH. As an additional functionality, the gNB can indicate the DAI value for each group separately in the UL grant to resolve any possible ambiguity at the UE side.

### D. One-Shot (Type-3) HARQ Codebook

The UE can be configured to monitor feedback request of a HARQ-ACK codebook containing all DL HARQ processes. The feedback can be requested in DL DCI 1_1. In response to the trigger, the UE reports the HARQ ACK feedback for all DL HARQ processes. The format of the feedback, CBG-based HARQ-ACK or TB-based HARQ-ACK, can be configured to be part of the one-shot HARQ feedback for the CCs configured with CBG.

Additionally, to resolve any possible ambiguity between the gNB and the UE that might be caused by possible mis-detection of PDCCH(s), the UE can be configured to reports the corresponding latest NDI value for a latest received PDSCH for that HARQ process along with the corresponding HARQ-ACK for the received PDSCH. From gNB perspective, if the NDI value matches the last transmitted value, it indicates that the reported HARQ-ACK feedback correctly corresponds to the HARQ process with pending feedback. Otherwise, the mismatch suggests that the UE is reporting an outdated feedback.

### E. PUCCH Repetition Procedure

NR supports PUCCH repetition over multiple slots. This is useful, e.g., for increased coverage. Only long PUCCH formats, namely formats 1, 3, and 4 are supported. Number of repetitions (2, 4, or 8 slots) across multiple slots is semi-statically configured by a higher layer parameter nrofSlots in PUCCH-FormatConfig in the PUCCH-config 1E (see FIG. 6). The same resource allocation (e.g., same number of consecutive symbols, same starting symbol) is used for each repetition over multiple slots. See Section 9.2.6 in TS 38.213 for the complete description. The semi-static configuration of the number of PUCCH repetitions by nrofSlots in PUCCH-FormatConfig is done per PUCCH format separately. Once it is configured, it is applied to all PUCCH resources of that particular format.

### F. Sub-Slot HARQ-ACK

In NR Rel-16, an enhancement on HARQ-ACK feedback is made to support more than one PUCCH carrying HARQ-ACK in a slot for supporting different services and for possible fast HARQ-ACK feedback for URLLC. This leads to an introduction of new HARQ-ACK timing in a unit of sub-slot, i.e., K1 indication in a unit of sub-slot. Sub-slot configurations for PUCCH carrying HARQ-ACK can be configured from the two options, namely “2-symbol*7” and “7-symbol*2” for the sub-slot length of 2 symbols and 7 symbols, respectively. The indication of K1 is the same as that of Rel-15, that is, K1 is indicated in the DCI scheduling PDSCH. To determine the HARQ-ACK timing, there exists an association of PDSCH to sub-slot configuration in that if the scheduled PDSCH ends in sub-slot n, the corresponding HARQ-ACK is reported in sub-slot n+K1. In a sense, sub-slot based HARQ-ACK timing works similarly to that of Rel-15 slot-based procedure by replacing the unit of K1 from slot to sub-slot.

There exist some limitations on PUCCH resources for sub-slot HARQ-ACK. That is, only one PUCCH resource configuration is used for all sub-slots in a slot. Moreover, any PUCCH resource for sub-slot HARQ-ACK cannot cross sub-slot boundaries.

FIG. 7 shows an example where each PDSCH is associated with a certain sub-slot for HARQ feedback through the use of a K1 value in units of sub-slots. In other words, FIG. 7 illustrates K1 indication based on sub-slots with “7-symbol*2” configuration for two PUCCHs in two sub-slots that carry the HARQ feedback of PDSCH transmissions.

### G. Priority Indication of HARQ-ACK

In Rel-16, two-level PHY priority can be indicated in the DCI for HARQ-ACK corresponding to a dynamically scheduled PDSCH or RRC-configured for HARQ-ACK corresponding to DL SPS. This priority indication can be used to determine the priority of the HARQ-ACK codebook for collision handling. NR Rel-16 supports up to two HARQ-ACK codebooks with different priorities to be simultaneously constructed. This includes one being slot-based and one being sub-slot-based, both being slot-based, or both being sub-slot-based.

### Non-Numerical K1 Values

As an enhancement to rel-15, the gNB can signal a non-numerical value in the PDSCH-to-HARQ-timing-indicator field in the DCI. When signaled, it indicates that the UE should hold on the HARQ-ACK feedback for the corresponding PDSCH until the timing and resource for the HARQ-ACK feedback is provided by the gNB in another DCI. The HARQ-ACK timing for PDSCH scheduled with non-numerical value for K1 is derived by the next DCI scheduling a PDSCH and indicating a numerical value in the PDSCH-to-HARQ-timing-indicator.

### VI. HARQ Feedback for UL Transmission (NR-U)

In NR-U or unlicensed spectrum, feedback for UL HARQ processes can be enabled.

Downlink feedback information (DFI): To reduce the signaling overhead corresponding to explicit feedback transmission, NR-U supports a new DCI format, downlink feedback information (“CG-DFI”), that carry HARQ-ACK bitmap for all UL HARQ processes from the same UE. Additionally, the gNB may trigger an adaptive retransmission using a dynamic grant.

In Section 6.1 in 3GPP TS 38.214 V 16.1.0, it is stated that
If a UE receives an ACK for a given HARQ process in CG-DFI in a PDCCH ending in symbol i to terminate a transport block repetition in a PUSCH transmission on a given serving cell with the same HARQ process after symbol i, the UE is expected to terminate the repetition of the transport block in a PUSCH transmission starting from a symbol j if the gap between the end of PDCCH of symbol i and the start of the PUSCH transmission in symbol j is equal to or more than N2 symbols. The value N2 in symbols is determined according to the UE processing capability defined in Clause 6.4, and N2 and the symbol duration are based on the minimum of the subcarrier spacing corresponding to the PUSCH and the subcarrier spacing of the PDCCH indicating CG-DFI.
For any RV sequence, the repetitions shall be terminated after transmitting K repetitions, or at the last transmission occasion among the K repetitions within the period P, or from the starting symbol of the repetition that overlaps with a PUSCH with the same HARQ process scheduled by DCI format 0_0, 0_1 or 0_2, whichever is reached first. In addition, the UE shall terminate the repetition of a transport block in a PUSCH transmission if the UE receives a DCI format 0_1 with DFI flag provided and set to ‘1’, and if in this DCI the UE detects ACK for the HARQ process corresponding to that transport block.

### VII. Multiple SPS/CGs

In order to reduce latency (transmission alignment delay), multiple SPS in DL or multiple CGs in UL can be allowed for delay sensitive services, e.g., URLLC. The node transmits in the resource which is available nearest to the data arrival [see Proposal 3 in R2-1900152].

### SUMMARY

Systems and methods are disclosed herein for transmission of Hybrid Automatic Repeat Request (HARQ) feedback for multiple Semi-Persistent Scheduling (SPS) or multiple Configured Grant (CG) transmission alignment. In one embodiment, a method performed by a wireless communication device comprises receiving N configurations, where N is an integer greater than one and the N configurations are N downlink semi-persistent scheduling, SPS, configurations or N uplink configured grant, CG, configurations. The method further comprises sending or receiving HARQ feedback for N physical uplink or downlink shared channels that are associated to the N configurations and belong to a same period, using a HARQ codebook that comprises a single HARQ acknowledgement or negative acknowledgement, ACK/NACK, for the N physical uplink or downlink shared channels. In this manner, construction of a smaller HARQ codebook is enabled, which helps in saving resources.

In one embodiment, data is transmitted on at most one of the N physical uplink or downlink shared channels.

In one embodiment, the single HARQ ACK/NACK is a single bit in the HARQ codebook. In another embodiment, the single HARQ ACK/NACK spans two or more bits in the HARQ codebook.

In one embodiment, the single HARQ ACK/NACK is repeated Y times in the HARQ codebook, where Y is an integer that is greater than 1. In another embodiment, the single HARQ ACK/NACK is a single bit that is repeated Y times in the HARQ codebook, where Y is an integer that is greater than 1.

In one embodiment, sending or receiving the HARQ feedback for the N physical uplink or downlink shared channels comprises sending or receiving Q repetitions of the HARQ codebook, where Q is an integer that is greater than or equal to 1.

In one embodiment, the method further comprises receiving control information that describes an allocation of the HARQ codebook for the N physical downlink or uplink shared channels. In one embodiment, the control information explicitly indicates a location of the HARQ codebook for a particular one of the N physical downlink or uplink shared channels. In one embodiment, the control information associates the N configurations.

In one embodiment, the HARQ codebook further comprises additional HARQ feedback. In one embodiment, the additional HARQ feedback comprises HARQ feedback for one or more dynamic physical downlink or uplink shared channels. In one embodiment, the additional HARQ feedback comprise HARQ feedback for one or more other SPS physical downlink shared channels or one or more other CG physical uplink shared channels.

Corresponding embodiments of a wireless communication device are also disclosed. In one embodiment, a wireless communication device is adapted to receive N configurations, where N is an integer greater than one and the N configurations are N downlink SPS configurations or N uplink CG configurations. The wireless communication device is further adapted to send or receive HARQ feedback for N physical uplink or downlink shared channels that are associated to the N configurations and belong to a same period, using a HARQ codebook that comprises a single HARQ acknowledgement or negative acknowledgement, ACK/NACK, for the N physical uplink or downlink shared channels.

In one embodiment, a wireless communication device comprises one or more transmitters, one or more receivers, and processing circuitry associated with the one or more transmitters and the one or more receivers. The processing circuitry is configured to cause the wireless communication device to receive N configurations, where N is an integer greater than one and the N configurations are N downlink SPS configurations or N uplink CG configurations. The processing circuitry is further configured to cause the wireless communication device to send or receive HARQ feedback for N physical uplink or downlink shared channels that are associated to the N configurations and belong to a same period, using a HARQ codebook that comprises a single HARQ acknowledgement or negative acknowledgement, ACK/NACK, for the N physical uplink or downlink shared channels.

Embodiments of a method performed by a base station are also disclosed. In one embodiment, a method performed by a base station comprises sending N configurations to a wireless communication device, where N is an integer greater than one and the N configurations are N downlink SPS configurations or N uplink CG configurations. The method further comprises sending or receiving HARQ feedback for N physical uplink or downlink shared channels that are associated to the N configurations and belong to a same period, using a HARQ codebook that comprises a single HARQ ACK/NACK for the N physical uplink or downlink shared channels.

In one embodiment, data is transmitted on at most one of the N physical uplink or downlink shared channels.

In one embodiment, the single HARQ ACK/NACK is a single bit in the HARQ codebook. In another embodiment, the single HARQ ACK/NACK spans two or more bits in the HARQ codebook.

In one embodiment, the single HARQ ACK/NACK is repeated Y times in the HARQ codebook, where Y is an integer that is greater than 1. In another embodiment, the single HARQ ACK/NACK is a single bit that is repeated Y times in the HARQ codebook, where Y is an integer that is greater than 1.

In one embodiment, sending or receiving the HARQ feedback for the N physical uplink or downlink shared channels comprises sending or receiving Q repetitions of the HARQ codebook, where Q is an integer that is greater than or equal to 1.

In one embodiment, the method further comprises sending, to the wireless communication device, control information that describes an allocation of the HARQ codebook for the N physical downlink or uplink shared channels. In one embodiment, the control information explicitly indicates a location of the HARQ codebook for a particular one of the N physical downlink or uplink shared channels. In one embodiment, the control information associates the N configurations.

In one embodiment, the HARQ codebook further comprises additional HARQ feedback. In one embodiment, the additional HARQ feedback comprises HARQ feedback for one or more dynamic physical downlink or uplink shared channels. In one embodiment, the additional HARQ feedback comprise HARQ feedback for one or more other SPS physical downlink shared channels or one or more other CG physical uplink shared channels.

Corresponding embodiments of a base station are also disclosed. In one embodiment, a base station is adapted to send N configurations to a wireless communication device, where N is an integer greater than one and the N configurations are N downlink SPS configurations or N uplink CG configurations. The base station is further adapted to send or receive HARQ feedback for N physical uplink or downlink shared channels that are associated to the N configurations and belong to a same period, using a HARQ codebook that comprises a single HARQ ACK/NACK for the N physical uplink or downlink shared channels.

In one embodiment, a base station comprises processing circuitry configured to cause the base station to send N configurations to a wireless communication device, where N is an integer greater than one and the N configurations are N downlink SPS configurations or N uplink CG configurations. The base station is further adapted to send or receive HARQ feedback for N physical uplink or downlink shared channels that are associated to the N configurations and belong to a same period, using a HARQ codebook that comprises a single HARQ ACK/NACK for the N physical uplink or downlink shared channels.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary radio resource in Third Generation Partnership Project (3GPP) New Radio (NR);

FIG. 2 illustrates the timeline in a simple scenario with two Physical Downlink Shared Channels (PDSCHs) and one Hybrid Automatic Repeat Request (HARQ) feedback;

FIG. 3 illustrates successful reception of a Physical Uplink Control Channel (PUCCH) by a NR base station (gNB);

FIG. 4 illustrates a PUCCH misdetection case where the gNB requests retransmission of earlier feedback;

FIG. 5 illustrates an example for enhanced dynamic HARQ codebook with two PDSCH groups;

FIG. 6 illustrates higher layer parameter nrofSlots in PUCCH-FormatConfig in the PUCCH-config Information Element (IE) in 3GPP NR;

FIG. 7 shows an example where each PDSCH is associated with a certain sub-slot for HARQ feedback through the use of a K1 value in units of sub-slots;

FIG. 8 illustrates that, using existing technology, N Semi-Persistent Scheduling (SPS) configurations require N HARQ codebooks or N bits or N information units to transmit HARQ feedback for each individual SPS's PDSCH;

FIG. 9 illustrates one example of a cellular communications system in which embodiments of the present disclosure may be implemented;

FIG. 10A illustrates an example of SPS/Configured Grant (CG) configurations with different offsets in accordance with embodiments of the present disclosure;

FIG. 10B illustrates an example with multiple SPS configurations in accordance with some embodiments of the present disclosure;

FIG. 11 illustrates an example in which a User Equipment (UE) sends an Acknowledgment (ACK) after receiving data on one of N=4 PDSCHs and hence one HARQ codebook or one information unit is used in the HARQ codebook construction, in accordance with one embodiment of the present disclosure;

FIG. 12 illustrates an example in which a UE sends a NACK if no data is received or data is not successfully decoded on any of N=4 PDSCHs and hence one HARQ codebook or one bit or one information unit is used in the HARQ codebook construction, in accordance with one embodiment of the present disclosure;

FIG. 13 illustrates the operation of a UE and a base station in accordance with embodiments of the present disclosure;

FIG. 14 illustrates the operation of a UE and a base station in accordance with embodiments of the present disclosure in relation to downlink SPS;

FIG. 15 illustrates the operation of a UE and a base station in accordance with embodiments of the present disclosure in relation to uplink CG;

FIGS. 16, 17, and 18 are schematic block diagrams of example embodiments of a radio access node;

FIGS. 19 and 20 are schematic block diagrams of example embodiments of a wireless communication device (e.g., a UE);

FIG. 21 illustrates an example embodiment of a communication system in which embodiments of the present disclosure may be implemented;

FIG. 22 illustrates example embodiments of the host computer, base station, and UE of FIG. 21; and

FIGS. 23, 24, 25, and 26 are flow charts that illustrate example embodiments of methods implemented in a communication system such as that of FIG. 21.

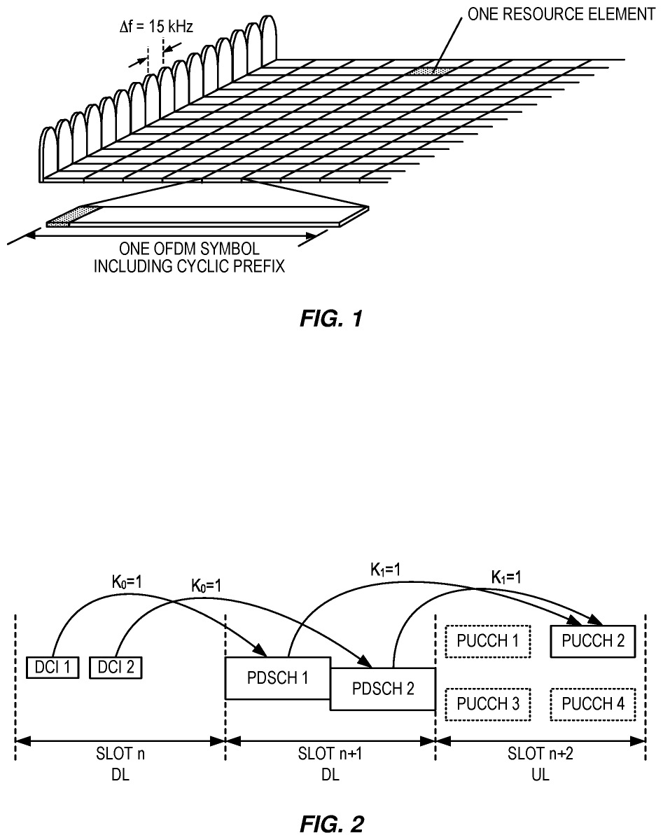

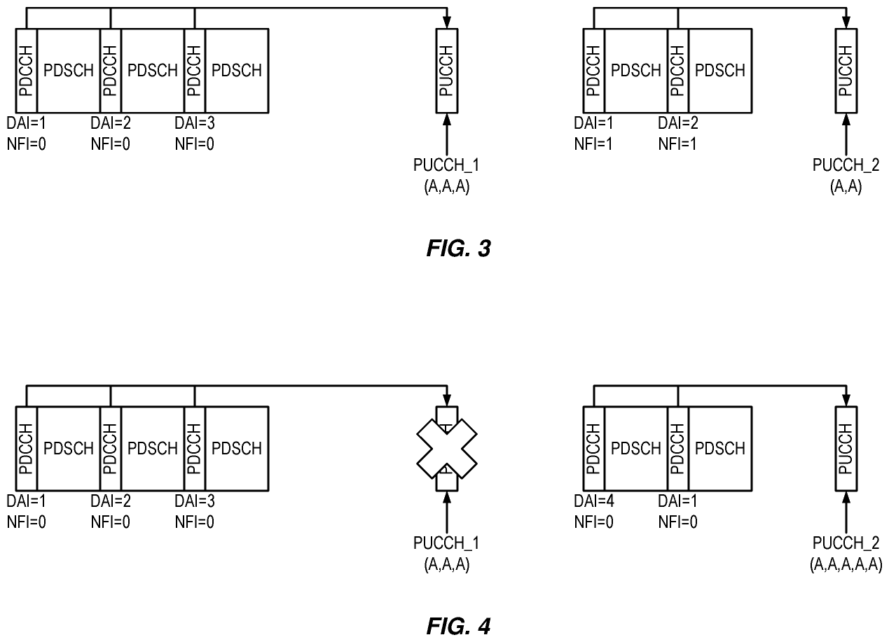

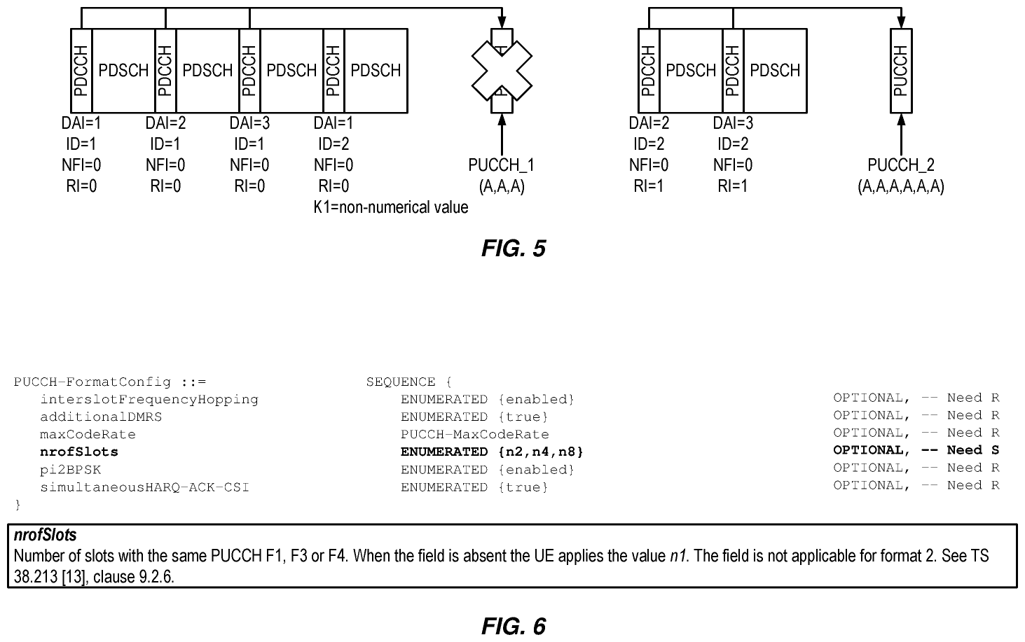

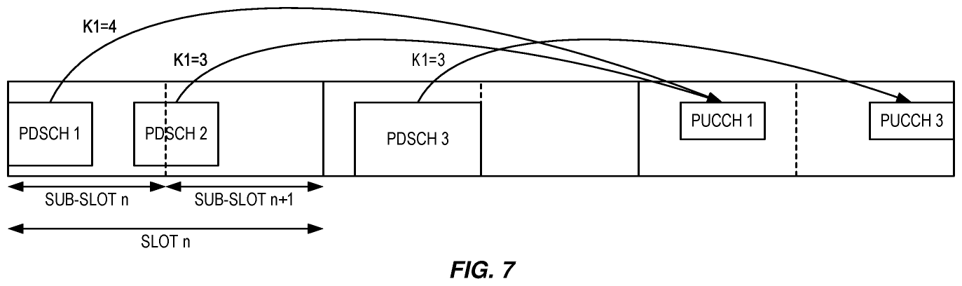

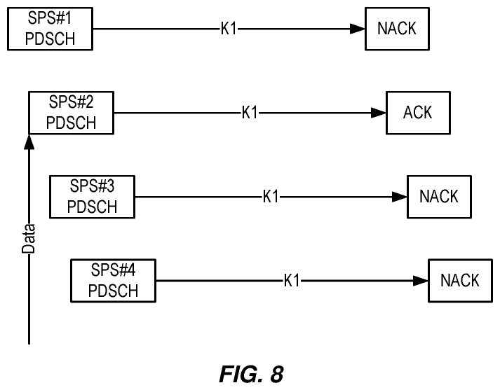

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In 3GPP Rel-16, multiple “N” Semi-Persistent Schedulings (SPSs) (or Configured Grants (CGs)) can be allocated for transmission alignment where only one of the SPSs (CGs) can be selected for the data (plus optional control information) out of the N configurations. These N configurations point to an N Hybrid Automatic Repeat Request (HARQ) feedback codebook(s) (e.g., in case of downlink (DL) data transmission, the codebook (CB) is located at slot K₁ with respect to the associated Physical Downlink Shared Channel (PDSCH)). Given that these N configurations are dependent, the codebook construction should be defined in accordance. Currently, these N configurations will need N bits for transmitting HARQ Acknowledgement (HARQ-ACK) feedback (see FIG. 8) which is un-necessary as there is going to be utilization of 1 configuration for transmission alignment.

FIG. 8 illustrates that, using existing technology, N SPS configurations require N CBs or N bits or N information units to transmit HARQ feedback for individual SPS's PDSCH.

Certain aspects of the present disclosure and their embodiments may provide solutions to the aforementioned or other challenges. Embodiments of the solutions disclosed herein enable the construction of HARQ codebook for HARQ feedback in the case with transmission/periodicity alignment where the UE is allocated with N configurations (DL SPSs or uplink (UL) CGs). A single HARQ codebook is allocated for N configurations where, within the HARQ CB, a placeholder for a single Negative ACK (NACK)/ACK (also denoted herein as “N/ACK”) is allocated instead of N N/ACKs (corresponding to the N configurations).

In one embodiment, multiple PDSCHs are allocated a single bit or a single information unit (single N/ACK) within a HARQ codebook.

Certain embodiments may provide one or more of the following technical advantage(s). Embodiments of the solutions proposed herein enable the construction of a smaller CB which helps in saving resources.

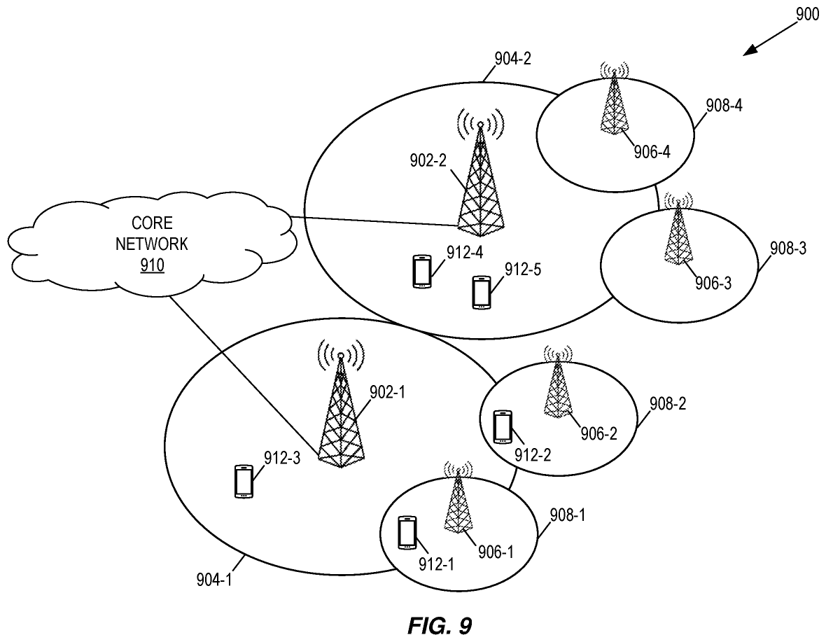

FIG. 9 illustrates one example of a cellular communications system 900 in which embodiments of the present disclosure may be implemented. In the embodiments described herein, the cellular communications system 900 is a 5G system (5GS) including a Next Generation RAN (NG-RAN) and a 5G Core (5GC); however, embodiments of the solutions disclosed herein are not limited thereto. In this example, the RAN includes base stations 902-1 and 902-2, which in the 5GS include NR base stations (gNBs) and optionally next generation eNBs (ng-eNBs) (e.g., LTE RAN nodes connected to the 5GC), controlling corresponding (macro) cells 904-1 and 904-2. The base stations 902-1 and 902-2 are generally referred to herein collectively as base stations 902 and individually as base station 902. Likewise, the (macro) cells 904-1 and 904-2 are generally referred to herein collectively as (macro) cells 904 and individually as (macro) cell 904. The RAN may also include a number of low power nodes 906-1 through 906-4 controlling corresponding small cells 908-1 through 908-4. The low power nodes 906-1 through 906-4 can be small base stations (such as pico or femto base stations) or Remote Radio Heads (RRHs), or the like. Notably, while not illustrated, one or more of the small cells 908-1 through 908-4 may alternatively be provided by the base stations 902. The low power nodes 906-1 through 906-4 are generally referred to herein collectively as low power nodes 906 and individually as low power node 906. Likewise, the small cells 908-1 through 908-4 are generally referred to herein collectively as small cells 908 and individually as small cell 908. The cellular communications system 900 also includes a core network 910, which in the 5G System (5GS) is referred to as the 5GC. The base stations 902 (and optionally the low power nodes 906) are connected to the core network 910.

The base stations 902 and the low power nodes 906 provide service to wireless communication devices 912-1 through 912-5 in the corresponding cells 904 and 908. The wireless communication devices 912-1 through 912-5 are generally referred to herein collectively as wireless communication devices 912 and individually as wireless communication device 912. In the following description, the wireless communication devices 912 are oftentimes UEs and as such sometimes referred to herein as UEs 912, but the present disclosure is not limited thereto.

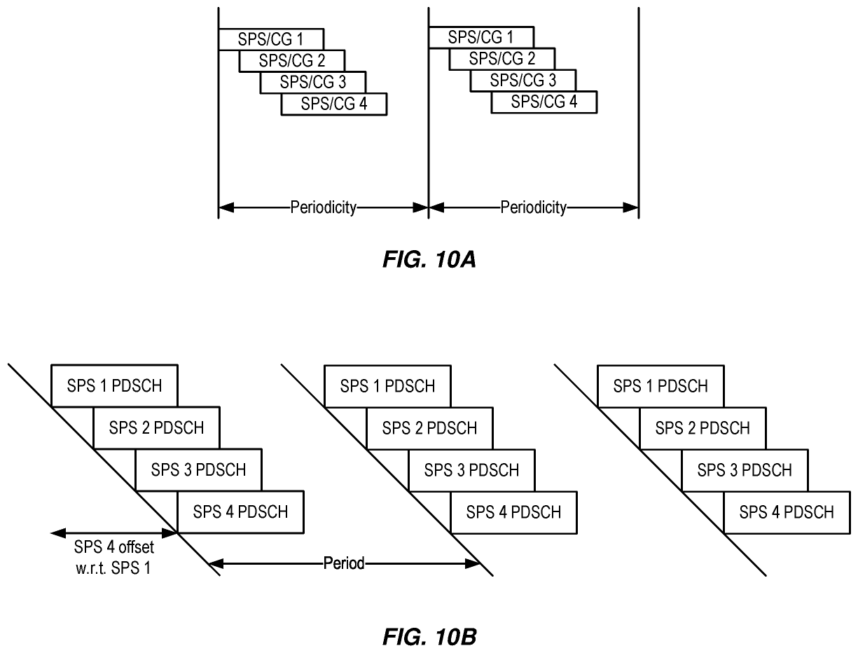

Now, a description of particular embodiments of the solutions disclosure herein is provided. In accordance with some non-limiting embodiments of the present disclosure, a HARQ-ACK codebook (CB) construction for a UE (e.g., a UE 912) allocated with N configurations (i.e., N DL SPSs or N UL CGs) can be described as follows. These N configurations' PXSCH (where X is D or U) belonging to the same period point to the same HARQ CB. PXSCHs belong to the “same period” means those PXSCHs of the N configurations which are differed with offsets, see FIGS. 10A and 10B. In particular, FIG. 10A illustrates an example of SPS/CG configurations with different offsets. FIG. 10B illustrates an example with multiple SPS configurations with four SPSs. The three SPS occasions are allocated with different offsets with respect to SPS 1. The period is the same for all SPSs, but the start and end times of the period are for different SPSs because their PDSCHs occasions start at different times. A similar example can be replicated for UL CGs.

In the HARQ CB, in one embodiment, there is one bit instead of N bits for N/ACK transmission to transmit a single N/ACK, as data will be sent on one configuration (PXSCH of one configuration) within the period. Note that 1-bit is an example. The objective to send either a single ACK or a single NACK for which a minimum of 1-bit is needed. In order to enhance reliability, the single N/ACK can be transmitted over multiple bits, but still it is a single piece of information. In another embodiment, in the HARQ CB, there is a placeholder for single N/ACK in the HARQ CB instead of N N/ACKs.

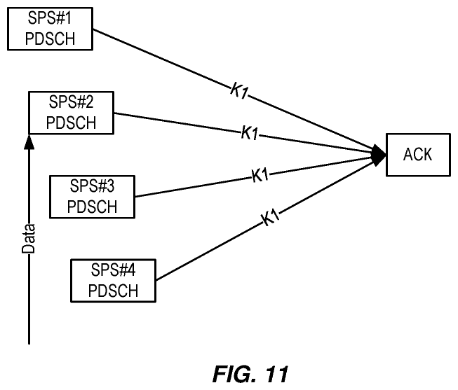

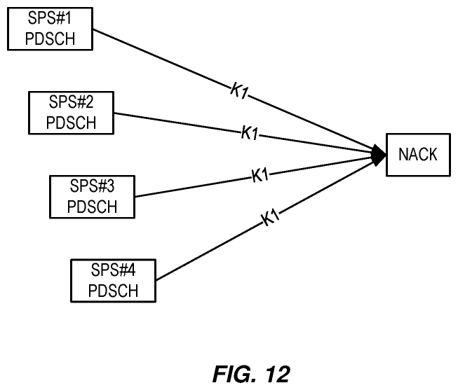

In one embodiment, the N/ACK selection in the HARQ CB can be done as follows. If data is decoded on one of the N configurations, then the node (e.g., the UE) sends a single ACK. In this regard, see the example of FIG. 11 in which the UE sends an ACK after receiving data on one of the N=4 PDSCHs and hence one HARQ CB or one information unit is used in the HARQ CB construction. If data could not be decoded on any of the N configurations, then the node (e.g., the UE) sends single NACK. In this regard, see the example of FIG. 12 in which the UE sends a NACK if no data is received or data is not successfully decoded on any of the N=4 PDSCHs and hence one HARQ CB or one bit or one information unit is used in the HARQ CB construction. The single N/ACK can span over 1 bit within the CB or over Y bits within the CB. Further if data is decoded in one of the SPS or configurations, then UE can skip decoding of PXSCH (PDSCH or PUSCH) in rest of the configurations within the period, as data is sent at the most in only one of the configurations within a period.

To achieve reliability for CB transmission, in one embodiment, the single N/ACK can be repeated P times within the CB, where P is an integer number that is greater than 1. In another embodiment, the HARQ CB can be repeated Q times, where Q is an integer number that is greater than 1. In another embodiment, the HARQ CB is repeated Q times where, within each HARQ CB, the single N/ACK repeated P times.

Note that the embodiments described herein apply to UL feedback for DL SPS transmissions or DL feedback for UL CG transmissions.

In some embodiments, the following aspects regarding control information describing HARQ CB allocation are also used. For ease of discussion, the UL feedback scenario for DL SPS transmissions is considered. For N DL SPSs configurations, the gNB (e.g., base station 902) can associate these N SPSs via Radio Resource Control (RRC) configuration or Downlink Control Information (DCI) command. In regard to RRC configuration, as an example, the gNB can group N SPSs, e.g., a group N=4 SPSs with SPS IDs {1, 0, 7, 3}. In regard to a DCI command, this command could be dedicated SPS activation command which mentions that this SPS is associated with group of N SPSs. For example, it can indicate Group ID ‘G’ which is mapped to relevant N SPS IDs, e.g., 4 SPS IDs {1, 0, 7, 3} map to Index G in RRC configuration. The DCI command could be group activation for N SPSs where the relevant SPS IDs, e.g., using above example of IDs {1, 0, 7, 3} are mentioned in the activation DCI, or the DCI indicates Group ID ‘G’ which is mapped to relevant SPS IDs, e.g., IDs {1, 0, 7, 3} map to Index G in RRC configuration.

Given the association of N SPSs, in some embodiments, the gNB explicitly indicates the HARQ CB location for the first/initial/any SPS. The location can be indicated in the SPS activation DCI or in RRC configuration. The rest of the N−1 SPSs will be implicitly understood that they are associated with HARQ CB of the SPS for which the location of the HARQ CB was explicitly indicated because these N−1 SPSs are linked with that SPS (e.g., via RRC configuration or DCI command, as described above). Alternatively, the rest of the N−1 SPSs can be explicitly indicated to have the same HARQ CB location corresponding to the HARQ CB for which the location was explicitly indicated. For example, different SPSs can have e.g., different K1s in the DCI but they point to the same CB location.

In one embodiment, the HARQ CB described above can contain other bits for transmitting HARQ-feedback for dynamic PDSCHs/PUSCHs or other SPS PDSCHs/CG PUSCHs (which are not part of the above N SPS/CG group). For example, a codebook is designed to send 3 N/ACK, one N/ACK is for dynamic PDSCH, one N/ACK is for SPS's PDSCH and one N/ACK for data transmission that occurs with N=4 SPSs (with transmission alignment use case). As one can note that, there will be 6 PDSCHs point to the codebook, however 4 PDSCHs are part of transmission alignment scenario, so only 1 N/ACK is needed, hence total 3 N/ACK will be transmitted in the codebook.

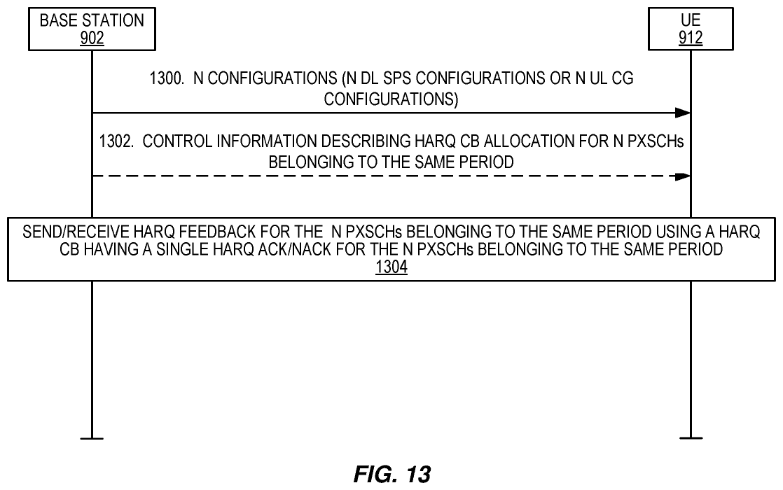

FIG. 13 illustrates the operation of a UE 912 and a base station 902 in accordance with at least some of the embodiments described above. Note that optional steps are represented by dashed lines/boxes. As illustrated, the base station 902 transmits and the UE 912 receives N configurations (step 1300). The N configurations are either N DL SPS configurations or N UL CG configurations. PXSCHs for the N configurations belonging to the same period are associated to (i.e., point to) the same HARQ codebook. In other words, a single HARQ codebook is allocated for the PXSCHs for the N configurations that belong to the same period. In some embodiments, the base station 902 transmits and the UE 912 receives control information describing the HARQ CB allocation for the PXSCHs for the N configurations that belong to the same period (step 1302). Details of this control information are provided above and not repeated here.

The base station 902 and the UE 912 then send/receive HARQ feedback for the N PXSCHs belonging to the same period using the HARQ codebook having a single HARQ ACK/NACK for the N PXSCHs belonging to the same period (step 1304). More specifically, as discussed above in one embodiment, the HARQ codebook includes a single HARQ ACK/NACK for the N PXSCHs, instead of HARQ ACK/NACKs for the N PXSCHs respectively. In one embodiment, the single HARQ ACK/NACK is a single bit. In another embodiment, as described above in order to increase reliability, the HARQ CB includes two or more repetitions of a single HARQ ACK/NACK for the N PXSCHs. For example, the HARQ CB may include Y bits for Y repetitions of a single bit HARQ ACK/NACK for the N PXSCHs. Also, as described above, the HARQ codebook (which itself may or may not include repetitions of the single HARQ ACK/NACK) is repeated Q times.

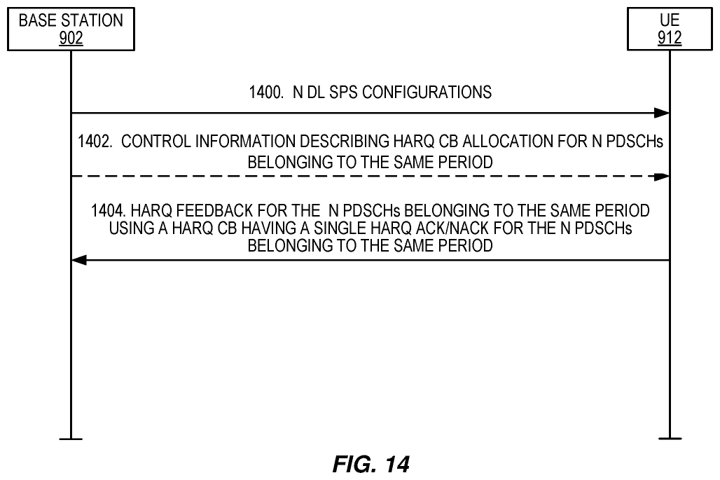

FIG. 14 illustrates the operation of a UE 912 and a base station 902 in accordance with at least some of the embodiments described above in relation to DL SPS. Note that optional steps are represented by dashed lines/boxes. As illustrated, the base station 902 transmits and the UE 912 receives N DL SPS configurations (step 1400). PDSCHs for the N DL SPS configurations belonging to the same period are associated to (i.e., point to) the same HARQ codebook. In other words, a single HARQ codebook is allocated for the PDSCHs for the N DL SPS configurations that belong to the same period. In some embodiments, the base station 902 transmits and the UE 912 receives control information describing the HARQ CB allocation for the PDSCHs for the N DL SPS configurations that belong to the same period (step 1402). Details of this control information are provided above and not repeated here.

The base station 902 transmits data on at least one of the N PDSCHs that belong to the same period for the N DL SPS configurations (step 1404). The UE 912 generates and transmits the HARQ codebook allocated for the N PDSCHs (step 1406). As discussed above in one embodiment, the HARQ codebook includes a single HARQ ACK/NACK for the N PXSCHs, instead of HARQ ACK/NACKs for the N PXSCHs respectively. In one embodiment, the single HARQ ACK/NACK is a single bit. In another embodiment, as described above in order to increase reliability, the HARQ CB includes two or more repetitions of a single HARQ ACK/NACK for the N PXSCHs. For example, the HARQ CB may include Y bits for Y repetitions of a single bit HARQ ACK/NACK for the N PXSCHs. Also, as described above, the HARQ codebook (which itself may or may not include repetitions of the single HARQ ACK/NACK) is repeated Q times.

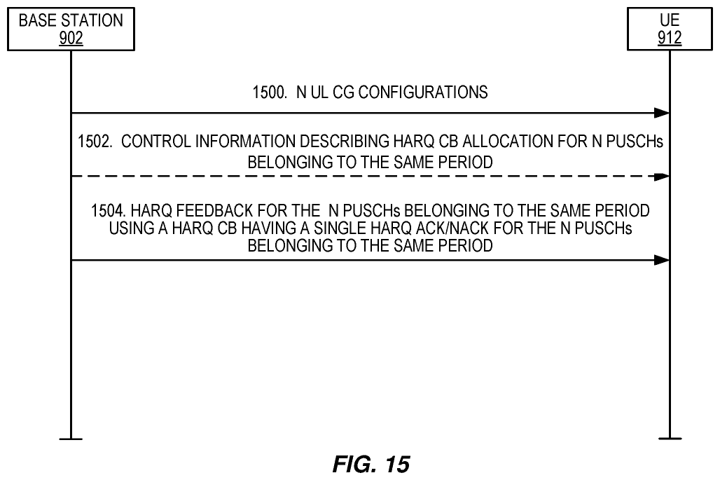

FIG. 15 illustrates the operation of a UE 912 and a base station 902 in accordance with at least some of the embodiments described above in relation to UL CGs. Note that optional steps are represented by dashed lines/boxes. As illustrated, the base station 902 transmits and the UE 912 receives N UE CG configurations (step 1500). PUSCHs for the N UL CG configurations belonging to the same period are associated to (i.e., point to) the same HARQ codebook. In other words, a single HARQ codebook is allocated for the PUSCHs for the N UL CG configurations that belong to the same period. In some embodiments, the base station 902 transmits and the UE 912 receives control information describing the HARQ CB allocation for the PUSCHs for the N UL CG configurations that belong to the same period (step 1402). Details of this control information are provided above and not repeated here.

The UE 912 transmits data on at least one of the N PUSCHs that belong to the same period for the N UL CG configurations (step 1504). The base station 902 generates and transmits the HARQ codebook allocated for the N PUSCHs (step 1506). As discussed above in one embodiment, the HARQ codebook includes a single HARQ ACK/NACK for the N PUSCHs, instead of HARQ ACK/NACKs for the N PUSCHs respectively. In one embodiment, the single HARQ ACK/NACK is a single bit. In another embodiment, as described above in order to increase reliability, the HARQ CB includes two or more repetitions of a single HARQ ACK/NACK for the N PUSCHs. For example, the HARQ CB may include Y bits for Y repetitions of a single bit HARQ ACK/NACK for the N PUSCHs. Also, as described above, the HARQ codebook (which itself may or may not include repetitions of the single HARQ ACK/NACK) is repeated Q times.

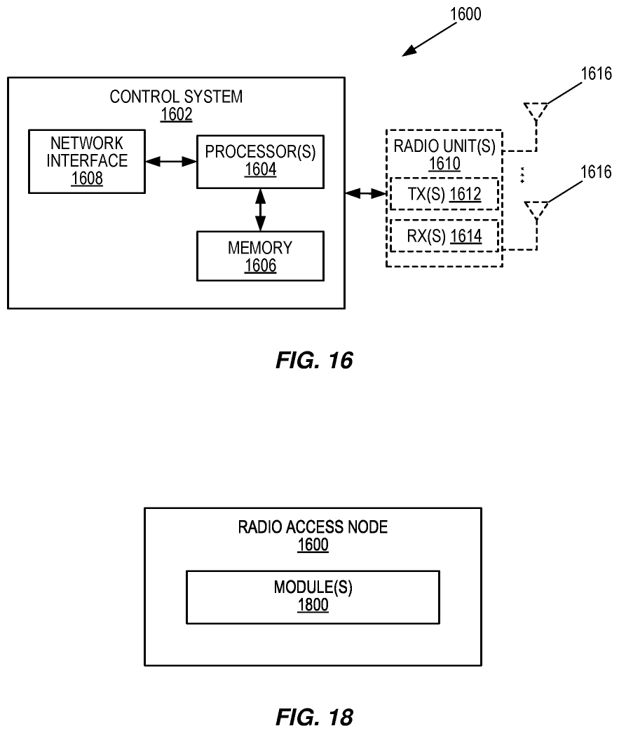

FIG. 16 is a schematic block diagram of a radio access node 1600 according to some embodiments of the present disclosure. Optional features are represented by dashed boxes. The radio access node 1600 may be, for example, a base station 902 or 906 or a network node that implements all or part of the functionality of the base station 902 or gNB described herein. As illustrated, the radio access node 1600 includes a control system 1602 that includes one or more processors 1604 (e.g., Central Processing Units (CPUs), Application Specific Integrated Circuits (ASICs), Field Programmable Gate Arrays (FPGAs), and/or the like), memory 1606, and a network interface 1608. The one or more processors 1604 are also referred to herein as processing circuitry. In addition, the radio access node 1600 may include one or more radio units 1610 that each includes one or more transmitters 1612 and one or more receivers 1614 coupled to one or more antennas 1616. The radio units 1610 may be referred to or be part of radio interface circuitry. In some embodiments, the radio unit(s) 1610 is external to the control system 1602 and connected to the control system 1602 via, e.g., a wired connection (e.g., an optical cable). However, in some other embodiments, the radio unit(s) 1610 and potentially the antenna(s) 1616 are integrated together with the control system 1602. The one or more processors 1604 operate to provide one or more functions of the radio access node 1600 as described herein (e.g., one or more functions of the base station 902 or gNB as described herein). In some embodiments, the function(s) are implemented in software that is stored, e.g., in the memory 1606 and executed by the one or more processors 1604.

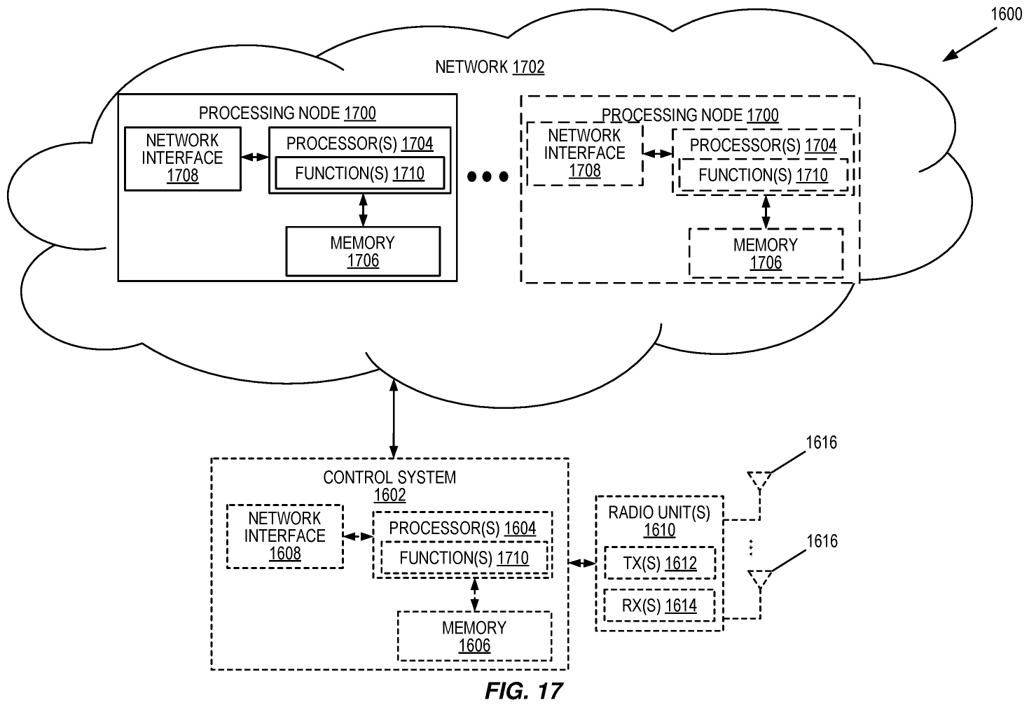

FIG. 17 is a schematic block diagram that illustrates a virtualized embodiment of the radio access node 1600 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1600 in which at least a portion of the functionality of the radio access node 1600 is implemented as a virtual component(s) (e.g., via a virtual machine(s) executing on a physical processing node(s) in a network(s)). As illustrated, in this example, the radio access node 1600 may include the control system 1602 and/or the one or more radio units 1610, as described above. The control system 1602 may be connected to the radio unit(s) 1610 via, for example, an optical cable or the like. The radio access node 1600 includes one or more processing nodes 1700 coupled to or included as part of a network(s) 1702. If present, the control system 1602 or the radio unit(s) are connected to the processing node(s) 1700 via the network 1702. Each processing node 1700 includes one or more processors 1704 (e.g., CPUs, ASICs, FPGAs, and/or the like), memory 1706, and a network interface 1708.

In this example, functions 1710 of the radio access node 1600 described herein (e.g., one or more functions of the base station 902 or gNB as described herein) are implemented at the one or more processing nodes 1700 or distributed across the one or more processing nodes 1700 and the control system 1602 and/or the radio unit(s) 1610 in any desired manner. In some particular embodiments, some or all of the functions 1710 of the radio access node 1600 described herein are implemented as virtual components executed by one or more virtual machines implemented in a virtual environment(s) hosted by the processing node(s) 1700. As will be appreciated by one of ordinary skill in the art, additional signaling or communication between the processing node(s) 1700 and the control system 1602 is used in order to carry out at least some of the desired functions 1710. Notably, in some embodiments, the control system 1602 may not be included, in which case the radio unit(s) 1610 communicate directly with the processing node(s) 1700 via an appropriate network interface(s).

In some embodiments, a computer program including instructions which, when executed by at least one processor, causes the at least one processor to carry out the functionality of radio access node 1600 or a node (e.g., a processing node 1700) implementing one or more of the functions 1710 of the radio access node 1600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the radio access node 1600 according to some other embodiments of the present disclosure. The radio access node 1600 includes one or more modules 1800, each of which is implemented in software. The module(s) 1800 provide the functionality of the radio access node 1600 described herein (e.g., one or more functions of the base station 902 or gNB as described herein). This discussion is equally applicable to the processing node 1700 of FIG. 17 where the modules 1800 may be implemented at one of the processing nodes 1700 or distributed across multiple processing nodes 1700 and/or distributed across the processing node(s) 1700 and the control system 1602.

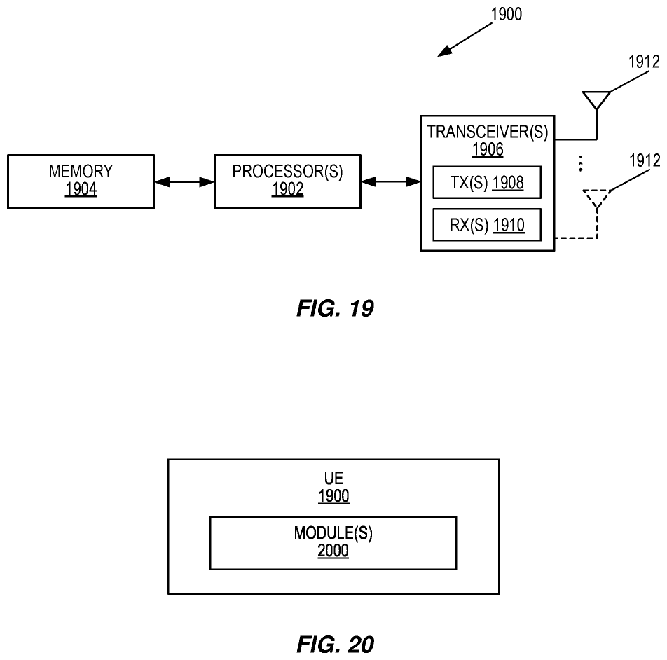

FIG. 19 is a schematic block diagram of a wireless communication device 1900 according to some embodiments of the present disclosure. The wireless communication device 1900 may be the UE 912. As illustrated, the wireless communication device 1900 includes one or more processors 1902 (e.g., CPUs, ASICs, FPGAs, and/or the like), memory 1904, and one or more transceivers 1906 each including one or more transmitters 1908 and one or more receivers 1910 coupled to one or more antennas 1912. The transceiver(s) 1906 includes radio-front end circuitry connected to the antenna(s) 1912 that is configured to condition signals communicated between the antenna(s) 1912 and the processor(s) 1902, as will be appreciated by on of ordinary skill in the art. The processors 1902 are also referred to herein as processing circuitry. The transceivers 1906 are also referred to herein as radio circuitry. In some embodiments, the functionality of the wireless communication device 1900 described above (e.g., one or more functions of the UE 912 or UE as described herein) may be fully or partially implemented in software that is, e.g., stored in the memory 1904 and executed by the processor(s) 1902. Note that the wireless communication device 1900 may include additional components not illustrated in FIG. 19 such as, e.g., one or more user interface components (e.g., an input/output interface including a display, buttons, a touch screen, a microphone, a speaker(s), and/or the like and/or any other components for allowing input of information into the wireless communication device 1900 and/or allowing output of information from the wireless communication device 1900), a power supply (e.g., a battery and associated power circuitry), etc.

In some embodiments, a computer program including instructions which, when executed by at least one processor, causes the at least one processor to carry out the functionality of the wireless communication device 1900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 20 is a schematic block diagram of the wireless communication device 1900 according to some other embodiments of the present disclosure. The wireless communication device 1900 includes one or more modules 2000, each of which is implemented in software. The module(s) 2000 provide the functionality of the wireless communication device 1900 described herein (e.g., one or more functions of the UE 912 or UE as described herein).

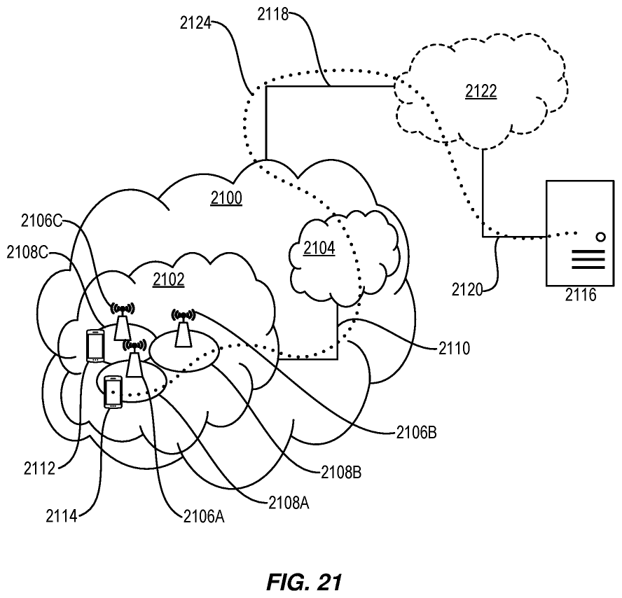

With reference to FIG. 21, in accordance with an embodiment, a communication system includes a telecommunication network 2100, such as a 3GPP-type cellular network, which comprises an access network 2102, such as a RAN, and a core network 2104. The access network 2102 comprises a plurality of base stations 2106A, 2106B, 2106C, such as Node Bs, eNBs, gNBs, or other types of wireless Access Points (APs), each defining a corresponding coverage area 2108A, 2108B, 2108C. Each base station 2106A, 2106B, 2106C is connectable to the core network 2104 over a wired or wireless connection 2110. A first UE 2112 located in coverage area 2108C is configured to wirelessly connect to, or be paged by, the corresponding base station 2106C. A second UE 2114 in coverage area 2108A is wirelessly connectable to the corresponding base station 2106A. While a plurality of UEs 2112, 2114 are illustrated in this example, the disclosed embodiments are equally applicable to a situation where a sole UE is in the coverage area or where a sole UE is connecting to the corresponding base station 2106.

The telecommunication network 2100 is itself connected to a host computer 2116, which may be embodied in the hardware and/or software of a standalone server, a cloud-implemented server, a distributed server, or as processing resources in a server farm. The host computer 2116 may be under the ownership or control of a service provider, or may be operated by the service provider or on behalf of the service provider. Connections 2118 and 2120 between the telecommunication network 2100 and the host computer 2116 may extend directly from the core network 2104 to the host computer 2116 or may go via an optional intermediate network 2122. The intermediate network 2122 may be one of, or a combination of more than one of, a public, private, or hosted network; the intermediate network 2122, if any, may be a backbone network or the Internet; in particular, the intermediate network 2122 may comprise two or more sub-networks (not shown).

The communication system of FIG. 21 as a whole enables connectivity between the connected UEs 2112, 2114 and the host computer 2116. The connectivity may be described as an Over-the-Top (OTT) connection 2124. The host computer 2116 and the connected UEs 2112, 2114 are configured to communicate data and/or signaling via the OTT connection 2124, using the access network 2102, the core network 2104, any intermediate network 2122, and possible further infrastructure (not shown) as intermediaries. The OTT connection 2124 may be transparent in the sense that the participating communication devices through which the OTT connection 2124 passes are unaware of routing of uplink and downlink communications. For example, the base station 2106 may not or need not be informed about the past routing of an incoming downlink communication with data originating from the host computer 2116 to be forwarded (e.g., handed over) to a connected UE 2112. Similarly, the base station 2106 need not be aware of the future routing of an outgoing uplink communication originating from the UE 2112 towards the host computer 2116.

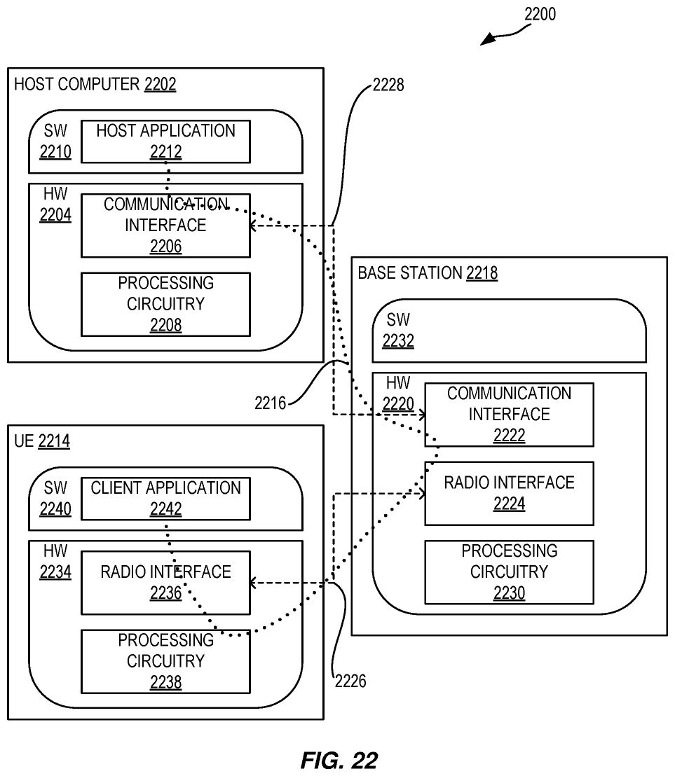

Example implementations, in accordance with an embodiment, of the UE, base station, and host computer discussed in the preceding paragraphs will now be described with reference to FIG. 22. In a communication system 2200, a host computer 2202 comprises hardware 2204 including a communication interface 2206 configured to set up and maintain a wired or wireless connection with an interface of a different communication device of the communication system 2200. The host computer 2202 further comprises processing circuitry 2208, which may have storage and/or processing capabilities. In particular, the processing circuitry 2208 may comprise one or more programmable processors, ASICs, FPGAs, or combinations of these (not shown) adapted to execute instructions. The host computer 2202 further comprises software 2210, which is stored in or accessible by the host computer 2202 and executable by the processing circuitry 2208. The software 2210 includes a host application 2212. The host application 2212 may be operable to provide a service to a remote user, such as a UE 2214 connecting via an OTT connection 2216 terminating at the UE 2214 and the host computer 2202. In providing the service to the remote user, the host application 2212 may provide user data which is transmitted using the OTT connection 2216.

The communication system 2200 further includes a base station 2218 provided in a telecommunication system and comprising hardware 2220 enabling it to communicate with the host computer 2202 and with the UE 2214. The hardware 2220 may include a communication interface 2222 for setting up and maintaining a wired or wireless connection with an interface of a different communication device of the communication system 2200, as well as a radio interface 2224 for setting up and maintaining at least a wireless connection 2226 with the UE 2214 located in a coverage area (not shown in FIG. 22) served by the base station 2218. The communication interface 2222 may be configured to facilitate a connection 2228 to the host computer 2202. The connection 2228 may be direct or it may pass through a core network (not shown in FIG. 22) of the telecommunication system and/or through one or more intermediate networks outside the telecommunication system. In the embodiment shown, the hardware 2220 of the base station 2218 further includes processing circuitry 2230, which may comprise one or more programmable processors, ASICs, FPGAs, or combinations of these (not shown) adapted to execute instructions. The base station 2218 further has software 2232 stored internally or accessible via an external connection.

The communication system 2200 further includes the UE 2214 already referred to. The UE's 2214 hardware 2234 may include a radio interface 2236 configured to set up and maintain a wireless connection 2226 with a base station serving a coverage area in which the UE 2214 is currently located. The hardware 2234 of the UE 2214 further includes processing circuitry 2238, which may comprise one or more programmable processors, ASICs, FPGAs, or combinations of these (not shown) adapted to execute instructions. The UE 2214 further comprises software 2240, which is stored in or accessible by the UE 2214 and executable by the processing circuitry 2238. The software 2240 includes a client application 2242. The client application 2242 may be operable to provide a service to a human or non-human user via the UE 2214, with the support of the host computer 2202. In the host computer 2202, the executing host application 2212 may communicate with the executing client application 2242 via the OTT connection 2216 terminating at the UE 2214 and the host computer 2202. In providing the service to the user, the client application 2242 may receive request data from the host application 2212 and provide user data in response to the request data. The OTT connection 2216 may transfer both the request data and the user data. The client application 2242 may interact with the user to generate the user data that it provides.

It is noted that the host computer 2202, the base station 2218, and the UE 2214 illustrated in FIG. 22 may be similar or identical to the host computer 2116, one of the base stations 2106A, 2106B, 2106C, and one of the UEs 2112, 2114 of FIG. 21, respectively. This is to say, the inner workings of these entities may be as shown in FIG. 22 and independently, the surrounding network topology may be that of FIG. 21.

In FIG. 22, the OTT connection 2216 has been drawn abstractly to illustrate the communication between the host computer 2202 and the UE 2214 via the base station 2218 without explicit reference to any intermediary devices and the precise routing of messages via these devices. The network infrastructure may determine the routing, which may be configured to hide from the UE 2214 or from the service provider operating the host computer 2202, or both. While the OTT connection 2216 is active, the network infrastructure may further take decisions by which it dynamically changes the routing (e.g., on the basis of load balancing consideration or reconfiguration of the network).

The wireless connection 2226 between the UE 2214 and the base station 2218 is in accordance with the teachings of the embodiments described throughout this disclosure. One or more of the various embodiments improve the performance of OTT services provided to the UE 2214 using the OTT connection 2216, in which the wireless connection 2226 forms the last segment. More precisely, the teachings of these embodiments may improve e.g., data rate, latency, and/or power consumption and thereby provide benefits such as, e.g., reduced user waiting time, relaxed restriction on file size, better responsiveness, and/or extended battery lifetime.

A measurement procedure may be provided for the purpose of monitoring data rate, latency, and other factors on which the one or more embodiments improve. There may further be an optional network functionality for reconfiguring the OTT connection 2216 between the host computer 2202 and the UE 2214, in response to variations in the measurement results. The measurement procedure and/or the network functionality for reconfiguring the OTT connection 2216 may be implemented in the software 2210 and the hardware 2204 of the host computer 2202 or in the software 2240 and the hardware 2234 of the UE 2214, or both. In some embodiments, sensors (not shown) may be deployed in or in association with communication devices through which the OTT connection 2216 passes; the sensors may participate in the measurement procedure by supplying values of the monitored quantities exemplified above, or supplying values of other physical quantities from which the software 2210, 2240 may compute or estimate the monitored quantities. The reconfiguring of the OTT connection 2216 may include message format, retransmission settings, preferred routing, etc.; the reconfiguring need not affect the base station 2218, and it may be unknown or imperceptible to the base station 2218. Such procedures and functionalities may be known and practiced in the art. In certain embodiments, measurements may involve proprietary UE signaling facilitating the host computer 2202's measurements of throughput, propagation times, latency, and the like. The measurements may be implemented in that the software 2210 and 2240 causes messages to be transmitted, in particular empty or ‘dummy’ messages, using the OTT connection 2216 while it monitors propagation times, errors, etc.

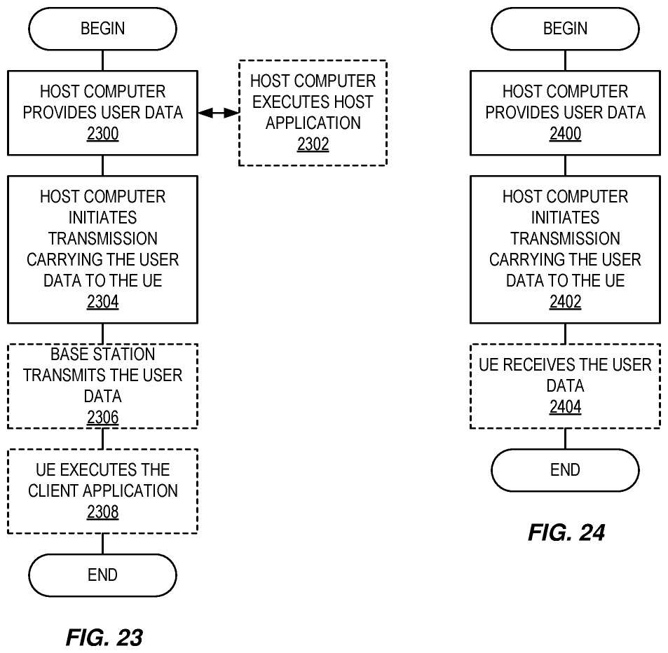

FIG. 23 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 23 will be included in this section. In step 2300, the host computer provides user data. In sub-step 2302 (which may be optional) of step 2300, the host computer provides the user data by executing a host application. In step 2304, the host computer initiates a transmission carrying the user data to the UE. In step 2306 (which may be optional), the base station transmits to the UE the user data which was carried in the transmission that the host computer initiated, in accordance with the teachings of the embodiments described throughout this disclosure. In step 2308 (which may also be optional), the UE executes a client application associated with the host application executed by the host computer.

FIG. 24 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 24 will be included in this section. In step 2400 of the method, the host computer provides user data. In an optional sub-step (not shown) the host computer provides the user data by executing a host application. In step 2402, the host computer initiates a transmission carrying the user data to the UE. The transmission may pass via the base station, in accordance with the teachings of the embodiments described throughout this disclosure. In step 2404 (which may be optional), the UE receives the user data carried in the transmission.

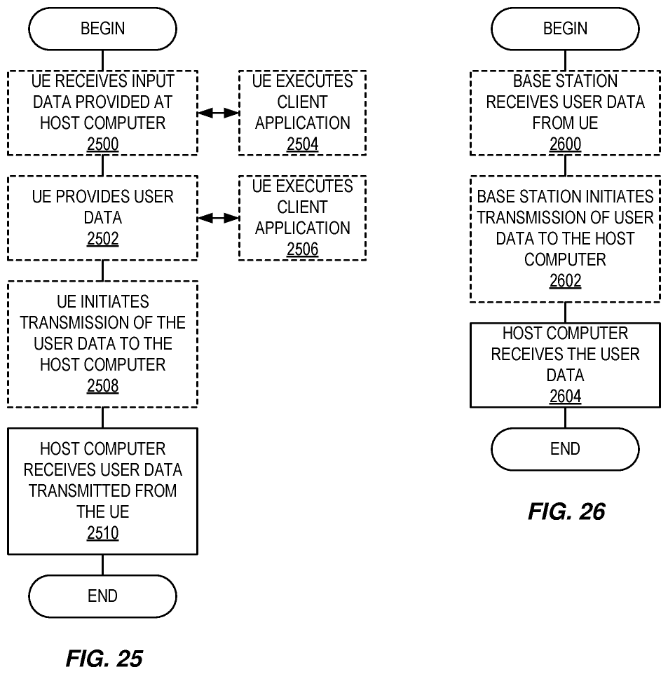

FIG. 25 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 25 will be included in this section. In step 2500 (which may be optional), the UE receives input data provided by the host computer. Additionally or alternatively, in step 2502, the UE provides user data. In sub-step 2504 (which may be optional) of step 2500, the UE provides the user data by executing a client application. In sub-step 2506 (which may be optional) of step 2502, the UE executes a client application which provides the user data in reaction to the received input data provided by the host computer. In providing the user data, the executed client application may further consider user input received from the user. Regardless of the specific manner in which the user data was provided, the UE initiates, in sub-step 2508 (which may be optional), transmission of the user data to the host computer. In step 2510 of the method, the host computer receives the user data transmitted from the UE, in accordance with the teachings of the embodiments described throughout this disclosure.

FIG. 26 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 26 will be included in this section. In step 2600 (which may be optional), in accordance with the teachings of the embodiments described throughout this disclosure, the base station receives user data from the UE. In step 2602 (which may be optional), the base station initiates transmission of the received user data to the host computer. In step 2604 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (912), comprising: receiving (1300; 1400; 1500) N configurations, where N is an integer greater than one and the N configurations are N downlink semi-persistent scheduling, SPS, configurations or N uplink configured grant, CG, configurations; and sending or receiving (1300; 1400; 1500) hybrid automatic repeat request, HARQ, feedback for N physical uplink or downlink shared channels that: (a) are associated to the N configurations and (b) belong to a same period, using a HARQ codebook that comprises a single HARQ acknowledgement or negative acknowledge, ACK/NACK, for the N physical uplink or downlink shared channels.

Embodiment 2: The method of embodiment 1 wherein data is transmitted on at most one of the N physical uplink or downlink shared channels.

Embodiment 3: The method of embodiment 1 or 2 wherein the single HARQ ACK/NACK is a single bit in the HARQ codebook.

Embodiment 4: The method of embodiment 1 or 2 wherein the single HARQ ACK/NACK spans two or more bits in the HARQ codebook.

Embodiment 5: The method of embodiment 1 or 2 wherein the single HARQ ACK/NACK is repeated Y times in the HARQ codebook, where Y is an integer that is greater than 1.

Embodiment 6: The method of embodiment 1 or 2 wherein the single HARQ ACK/NACK is a single bit that is repeated Y times in the HARQ codebook, where Y is an integer that is greater than 1.

Embodiment 7: The method of any of embodiments 1 to 6 wherein sending or receiving (1300; 1400; 1500) the HARQ feedback for the N physical uplink or downlink shared channels comprises sending or receiving Q repetitions of the HARQ codebook, where Q is an integer that is greater than or equal to 1.

Embodiment 8: The method of any of embodiments 1 to 7 further comprising receiving (1302; 1402; 1502) control information that describes an allocation of the HARQ codebook for the N physical downlink or uplink shared channels.

Embodiment 9: The method of embodiment 8 wherein the control information explicitly indicates a location of the HARQ codebook for a particular one of the N physical downlink or uplink shared channels.

Embodiment 10: The method of embodiment 8 or 9 wherein the control information associates the N configurations.

Embodiment 11: The method of any of embodiments 1 to 8 wherein the HARQ codebook further comprises additional HARQ feedback.

Embodiment 12: The method of embodiment 11 wherein the additional HARQ feedback comprises HARQ feedback for one or more dynamic physical downlink or uplink shared channels.

Embodiment 13: The method of embodiment 11 or 12 wherein the additional HARQ feedback comprise HARQ feedback for one or more other SPS physical downlink shared channels or one or more other CG physical uplink shared channels.

Embodiment 14: The method of any of the previous embodiments, further comprising: providing user data; and forwarding the user data to a host computer via the transmission to the base station.

### Group B Embodiments

Embodiment 15: A method performed by a base station (902) comprising: sending (1300; 1400; 1500) N configurations to a wireless communication device (912), where N is an integer greater than one and the N configurations are N downlink semi-persistent scheduling, SPS, configurations or N uplink configured grant, CG, configurations; and sending or receiving (1300; 1400; 1500) hybrid automatic repeat request, HARQ, feedback for N physical uplink or downlink shared channels that: (a) are associated to the N configurations and (b) belong to a same period, using a HARQ codebook that comprises a single HARQ acknowledgement or negative acknowledge, ACK/NACK, for the N physical uplink or downlink shared channels.

Embodiment 16: The method of embodiment 15 wherein data is transmitted on at most one of the N physical uplink or downlink shared channels.

Embodiment 17: The method of embodiment 15 or 16 wherein the single HARQ ACK/NACK is a single bit in the HARQ codebook.

Embodiment 18: The method of embodiment 15 or 16 wherein the single HARQ ACK/NACK spans two or more bits in the HARQ codebook.

Embodiment 19: The method of embodiment 15 or 16 wherein the single HARQ ACK/NACK is repeated Y times in the HARQ codebook, where Y is an integer that is greater than 1.

Embodiment 20: The method of embodiment 15 or 16 wherein the single HARQ ACK/NACK is a single bit that is repeated Y times in the HARQ codebook, where Y is an integer that is greater than 1.

Embodiment 21: The method of any of embodiments 15 to 20 wherein sending or receiving (1300; 1400; 1500) the HARQ feedback for the N physical uplink or downlink shared channels comprises sending or receiving Q repetitions of the HARQ codebook, where Q is an integer that is greater than or equal to 1.

Embodiment 22: The method of any of embodiments 15 to 21 further comprising sending (1302; 1402; 1502), to the wireless communication device (912), control information that describes an allocation of the HARQ codebook for the N physical downlink or uplink shared channels.

Embodiment 23: The method of embodiment 22 wherein the control information explicitly indicates a location of the HARQ codebook for a particular one of the N physical downlink or uplink shared channels.

Embodiment 24: The method of embodiment 22 or 23 wherein the control information associates the N configurations.

Embodiment 25: The method of any of embodiments 15 to 24 wherein the HARQ codebook further comprises additional HARQ feedback.

Embodiment 26: The method of embodiment 25 wherein the additional HARQ feedback comprises HARQ feedback for one or more dynamic physical downlink or uplink shared channels.

Embodiment 27: The method of embodiment 25 or 26 wherein the additional HARQ feedback comprise HARQ feedback for one or more other SPS physical downlink shared channels or one or more other CG physical uplink shared channels.

Embodiment 28: The method of any of the previous embodiments, further comprising: obtaining user data; and forwarding the user data to a host computer or a wireless communication device.

### Group C Embodiments

Embodiment 29: A wireless communication device comprising: processing circuitry configured to perform any of the steps of any of the Group A embodiments; and power supply circuitry configured to supply power to the wireless communication device.

Embodiment 30: A base station comprising: processing circuitry configured to perform any of the steps of any of the Group B embodiments; and power supply circuitry configured to supply power to the base station.

Embodiment 31: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 32: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 33: The communication system of the previous embodiment further including the base station.

Embodiment 34: The communication system of the previous 2 embodiments, further including the UE, wherein the UE is configured to communicate with the base station.

Embodiment 35: The communication system of the previous 3 embodiments, wherein: the processing circuitry of the host computer is configured to execute a host application, thereby providing the user data; and the UE comprises processing circuitry configured to execute a client application associated with the host application.

Embodiment 36: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 37: The method of the previous embodiment, further comprising, at the base station, transmitting the user data.

Embodiment 38: The method of the previous 2 embodiments, wherein the user data is provided at the host computer by executing a host application, the method further comprising, at the UE, executing a client application associated with the host application.

Embodiment 39: A User Equipment, UE, configured to communicate with a base station, the UE comprising a radio interface and processing circuitry configured to perform the method of the previous 3 embodiments.

Embodiment 40: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 41: The communication system of the previous embodiment, wherein the cellular network further includes a base station configured to communicate with the UE.

Embodiment 42: The communication system of the previous 2 embodiments, wherein: the processing circuitry of the host computer is configured to execute a host application, thereby providing the user data; and the UE's processing circuitry is configured to execute a client application associated with the host application.

Embodiment 43: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 44: The method of the previous embodiment, further comprising at the UE, receiving the user data from the base station.

Embodiment 45: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 46: The communication system of the previous embodiment, further including the UE.

Embodiment 47: The communication system of the previous 2 embodiments, further including the base station, wherein the base station comprises a radio interface configured to communicate with the UE and a communication interface configured to forward to the host computer the user data carried by a transmission from the UE to the base station.

Embodiment 48: The communication system of the previous 3 embodiments, wherein: the processing circuitry of the host computer is configured to execute a host application; and the UE's processing circuitry is configured to execute a client application associated with the host application, thereby providing the user data.

Embodiment 49: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 50: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 51: The method of the previous embodiment, further comprising, at the UE, providing the user data to the base station.

Embodiment 52: The method of the previous 2 embodiments, further comprising: at the UE, executing a client application, thereby providing the user data to be transmitted; and at the host computer, executing a host application associated with the client application.

Embodiment 53: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 54: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 55: The communication system of the previous embodiment further including the base station.

Embodiment 56: The communication system of the previous 2 embodiments, further including the UE, wherein the UE is configured to communicate with the base station.

Embodiment 57: The communication system of the previous 3 embodiments, wherein: the processing circuitry of the host computer is configured to execute a host application; and the UE is configured to execute a client application associated with the host application, thereby providing the user data to be received by the host computer.

Embodiment 58: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 59: The method of the previous embodiment, further comprising at the base station, receiving the user data from the UE.

Embodiment 60: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device, comprising:
receiving N configurations, where N is an integer greater than one and the N configurations are N downlink semi-persistent scheduling (SPS) configurations or N uplink configured grant (CG) configurations; and
sending or receiving hybrid automatic repeat request (HARQ) feedback for N physical uplink or downlink shared channels that are associated to the N configurations and belong to a same period, using a HARQ codebook that comprises a single HARQ acknowledgement or negative acknowledgement (ACK/NACK) for the N physical uplink or downlink shared channels.

2. The method of claim 1 wherein data is transmitted on at most one of the N physical uplink or downlink shared channels.

3. The method of claim 1 wherein the single HARQ ACK/NACK is a single bit in the HARQ codebook.

4. The method of claim 1 wherein the single HARQ ACK/NACK spans two or more bits in the HARQ codebook.

5. The method of claim 1 wherein the single HARQ ACK/NACK is repeated Y times in the HARQ codebook, where Y is an integer that is greater than 1.

6. The method of claim 1 wherein the single HARQ ACK/NACK is a single bit that is repeated Y times in the HARQ codebook, where Y is an integer that is greater than 1.

7. The method of claim 1 wherein sending or receiving the HARQ feedback for the N physical uplink or downlink shared channels comprises sending or receiving Q repetitions of the HARQ codebook, where Q is an integer that is greater than or equal to 1.

8. The method of claim 1 further comprising receiving control information that describes an allocation of the HARQ codebook for the N physical downlink or uplink shared channels.

9. The method of claim 8 wherein the control information explicitly indicates a location of the HARQ codebook for a particular one of the N physical downlink or uplink shared channels.

10. The method of claim 8 wherein the control information associates the N configurations.

11. The method of claim 1 wherein the HARQ codebook further comprises additional HARQ feedback.

12. The method of claim 11 wherein the additional HARQ feedback comprises HARQ feedback for one or more dynamic physical downlink or uplink shared channels.

13. The method of claim 11 wherein the additional HARQ feedback comprise HARQ feedback for one or more other SPS physical downlink shared channels or one or more other CG physical uplink shared channels.

14. (canceled)

15. (canceled)

16. A wireless communication device comprising:
one or more transmitters;
one or more receivers; and
processing circuitry associated with the one or more transmitters and the one or more receivers, the processing circuitry configured to cause the wireless communication device to:
receive N configurations, where N is an integer greater than one and the N configurations are N downlink semi-persistent scheduling (SPS) configurations or N uplink configured grant (CG) configurations; and
send or receive hybrid automatic repeat request (HARQ) feedback for N physical uplink or downlink shared channels that are associated to the N configurations and belong to a same period, using a HARQ codebook that comprises a single HARQ acknowledgement or negative acknowledgement (ACK/NACK) for the N physical uplink or downlink shared channels.

17. (canceled)

18. A method performed by a base station comprising:
sending N configurations to a wireless communication device, where N is an integer greater than one and the N configurations are N downlink semi-persistent scheduling (SPS) configurations or N uplink configured grant (CG) configurations; and
sending or receiving hybrid automatic repeat request (HARQ) feedback for N physical uplink or downlink shared channels that are associated to the N configurations and belong to a same period, using a HARQ codebook that comprises a single HARQ acknowledgement or negative acknowledgement (ACK/NACK for the N physical uplink or downlink shared channels.

19. The method of claim 18 wherein data is transmitted on at most one of the N physical uplink or downlink shared channels.

20. The method of claim 18 wherein the single HARQ ACK/NACK is a single bit in the HARQ codebook.

21. The method of claim 18 wherein the single HARQ ACK/NACK spans two or more bits in the HARQ codebook.

22. The method of claim 18 wherein the single HARQ ACK/NACK is repeated Y times in the HARQ codebook, where Y is an integer that is greater than 1.

23. The method of claim 18 wherein the single HARQ ACK/NACK is a single bit that is repeated Y times in the HARQ codebook, where Y is an integer that is greater than 1.

24-34. (canceled)
